(19) United States
(12) Patent Application Publication
(10) Pub. No.: US 2009/0216551 A1
(43) Pub. Date: Aug. 27, 2009

(54) METHOD AND SYSTEM FOR MANAGING SOCIAL NETWORKS OF A USER

(75) Inventors: Hui Chen, New York, NY (US); Luciano Mazzella, New York, NY (US); Roxy Wu, New York, NY (US)

Correspondence Address: PERKINS COIE LLP, P.O. BOX 1208, SEATTLE, WA, 98111-1208, US

(73) Assignee: Project Omega, Inc., New York, NY (US)

(21) Appl. No.: 12/391,839

(22) Filed: Feb. 24, 2009

Related U.S. Application Data
(60) Provisional application No. 61/031,497, filed on Feb. 26, 2008.

(51) Int. Cl. G06Q 10/00; G06F 7/06; G06F 3/048; G06F 17/30

(52) U.S. Cl. 705/1; 707/5; 715/738; 707/E17.044; 707/E17.141; 707/E17.014

(57) ABSTRACT

A method and system for managing a social network are provided. The method includes establishing a user profile, wherein the user profile includes basic information fields and supplemental information fields. The method includes receiving a user-defined criteria defining how a display profile will be compiled based, in part, on a relationship to a prospective viewer. The method includes, responsive to a request from the prospective viewer, compiling fields from the basic information fields and the supplemental information fields into the display profile. The method includes providing the display profile to the prospective viewer.

### CROSS REFERENCE TO RELATED APPLICATIONS

This application claims priority to provisional application No. 61/031,497 entitled “METHOD AND SYSTEM FOR LINKING NODES THROUGH DIFFERENT FACES IN SOCIAL NETWORKING” filed on Feb. 26, 2008, and which is incorporated herein by reference.

### FIELD OF THE INVENTION

The present invention relates generally to computing software for managing a social network, and more particularly to a method and system for managing the face of an individual user.

### BACKGROUND

Social network is a social structure made of nodes (which are generally individuals) that are tied by one or more specific types of interdependency, such as values, visions, idea, financial exchange, friends, kinship, dislike, conflict, trade, web links, sexual relations, disease transmission (epidemiology), or airline routes. The resulting structures are often very complex.

Currently social network analysis views social relationships in terms of nodes and ties. Nodes are the individual actors within the networks, and ties are the relationships between the actors. There can be many kinds of ties between the nodes. Research in a number of academic fields has shown that social networks operate on many levels, from families up to the level of nations, and play a critical role in determining the way problems are solved, organizations are run, and the degree to which individuals succeed in achieving their goals.

In its simplest form, a social network is a map of all of the relevant ties between the nodes being studied. The network can also be used to determine the social capital of individual actors. These concepts are often displayed in a social network diagram, where nodes are the points and ties are the lines.

Today's people are different from any generation before them. They are exposed to digital technology in virtually all facets of their day-to-day existence, and it is not difficult to see that people are interacting with different persons with different faces. For example, people can have friends through their professional face, and have friends via their academic face. Each faces are nodes and should be properly reflected in the complex relationships between social network users. Without the ability to interact with other users via different faces, social networking loses its appeal. Thus, there is a need in the industry for better mechanisms to manage, mine, and cultivate personal networks.

### SUMMARY OF THE INVENTION

In one embodiment, the user may establish a basic profile that includes a predetermined set of information about the user. A category may be established that has associated with it a set of user specified category profile information about the user. The category profile information and the basic profile information may then be employed to present a customized view of the user for that category.

Additionally, the user may elect to join an activity, such as a job search activity, religious activity, and the like. Activity profile information may be established based, in part, on a globally defined set of social network user information, to encourage a community sharing of common information related to the activity. Profile information may then be provided that is employable to present potentially yet another view of the user.

In another embodiment, the user may further rate a strength of a relationship between themselves and another social network user. The other social network user may then be permitted to view selected profile information based on the relationship strength.

In still another embodiment, profile information may be made available based, in part, on an affiliation of the other social network user to an online group, such as a Yahoo! group, and the like, an offline group, such as a fishing club, and the like.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 illustrates an example system for managing a user's social networks.

FIG. 2 illustrates an example telecommunication network for managing a user's social networks.

FIG. 3 illustrates an example Social Networking Server (SNS) for managing a user's social networks.

FIG. 4 illustrates an example data storage system for managing a user's social networks.

FIG. 5 illustrates an example Face Manager Software System (FMSS) for managing a user's social networks.

FIG. 6 illustrates an example Profile Storage System (PSS) data structure for managing a user's social networks.

FIG. 7 illustrates an example procedure for receiving user profile information.

FIG. 8 illustrates an example procedure for providing a customized view of social network user information.

FIG. 9 illustrates an example mobile device for managing a user's social networks.

FIG. 10 illustrates an example server for managing a user's social networks.

FIG. 11A illustrates a prior art relationship between users in a social networking environment.

FIG. 11B illustrates an example relationship between users in a face-oriented social networking environment.

FIG. 11C illustrates a prior art relationship between users belonging to a group in a social networking environment.

FIG. 11D illustrates an example relationship between users belonging to a group in a face-oriented social networking environment.

### DETAILED DESCRIPTION

The present invention provides an improved method, system, and apparatus for managing a view of a social network user's personal information based, in part, on user-defined criteria. The user-defined criteria may be applied towards a user's relationship with each prospective viewer. The user-defined criteria may include degrees of separation between members of the social network, a relationship to the prospective viewer, as well as criteria based, in part, on activities, such as dating, employment, hobbies, and the like. Such user-defined relationship criteria may then be mapped against various categories of information associated with social network user to provide customized views of the social network user. Such customized views may be employed to portray various persons to other users of the social network, and to enhance one's own overall value of the social networking experience. Moreover, employing such categories may minimize the likelihood of spam mailings. For example, a category may be employed for use in a spam filter, and the like, by determining whether a sender is a member of a category.

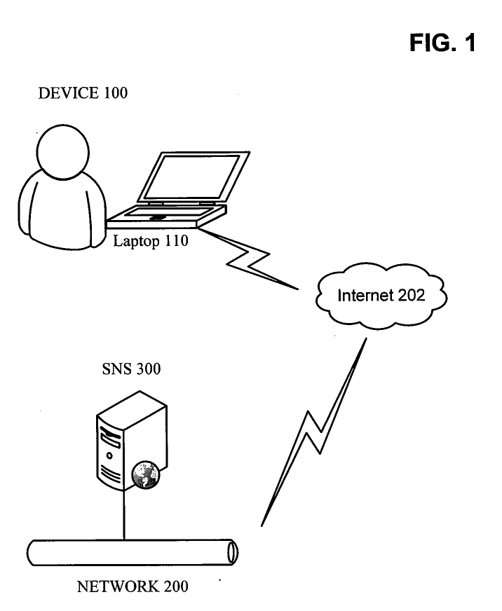

FIG. 1 illustrates an example system for managing a user's social networks. Client devices 100 may include any computing device capable of receiving and sending a message over a network, such as network 200, to and from another computing device, such as SNS 300, each other, and the like. The client devices 100 can include a laptop 110. The client devices 102 can communicate with the network 200 over a network such as the Internet 202.

The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, client devices 100 may be any device that is capable of connecting using a wired or wireless communication medium such as a PDA, POCKET PC, wearable computer, and any other device that is equipped to communicate over a wired and/or wireless communication medium.

Each client device of client devices 100 may include a browser application that is configured to receive and to send web pages, and the like. The browser application may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like.

Client devices 100 may be further configured to receive a message from the another computing device employing another mechanism, including, but not limited to email, Short Message Service (SMS), Multimedia Message Service (MMS), instant messaging (IM), internet relay chat (IRC), mIRC, Jabber, and the like.

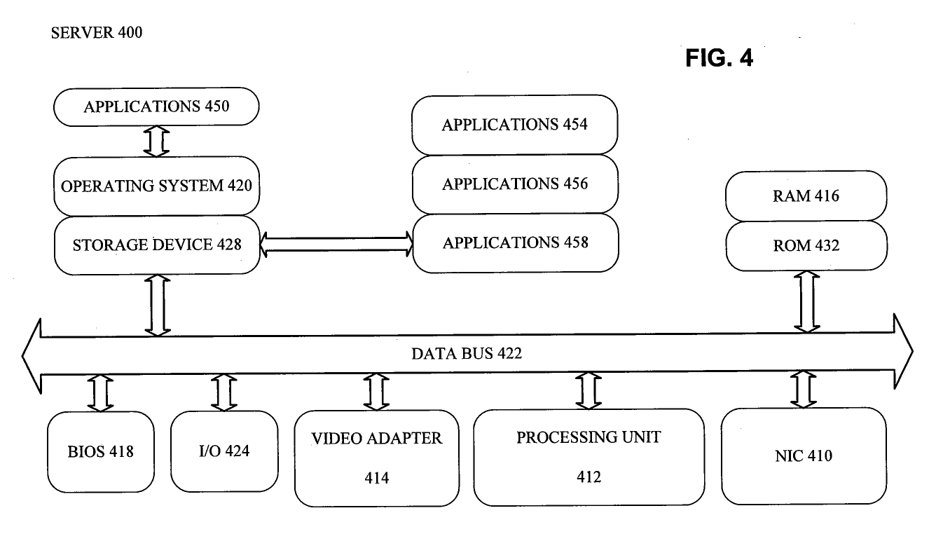

Client devices 100 may be further configured to enable a user to manage a user profile, category information, activity participation, and the like, which may in turn be saved at a remote location, such as SNS 300, and the like. As such, client devices 100 may further include a client application that is configured to manage various actions on behalf of the client device. For example, the client application may enable a user to interact with the browser application, email application, and the like, to customize how another social network user might view a persona, profile, or the like associated with the user. For example, the user may employ the client application, in part, to provide one customized view for family members, another customized view for poker members, yet another view for fishing buddies, and the like. The client application may interact with a process such as described below in conjunction with FIG. 4 to customize and manage such views.

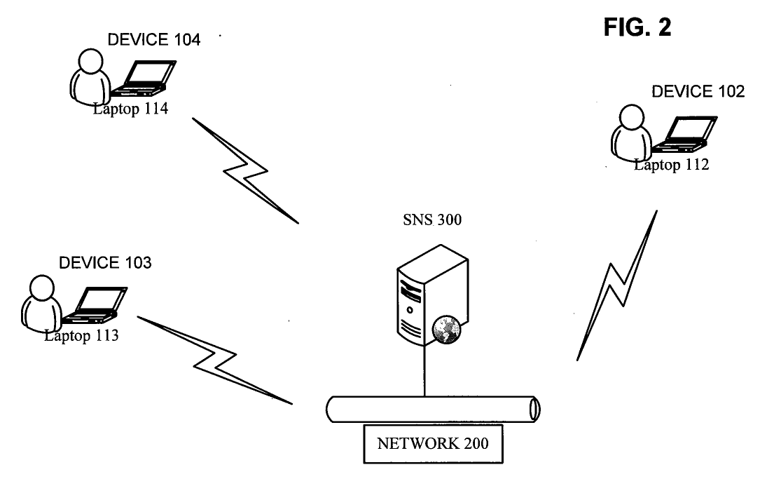

FIG. 2 illustrates an example telecommunication network for managing a user's social networks. Network 200 is configured to couple one computing device to another computing device to enable them to communicate. Network 200 is enabled to employ any form of computer readable media for communicating information from one electronic device to another. Also, network 200 may include a wireless interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 200 includes any communication method by which information may travel between client devices 102, 103, 104, and SNS 300. The client devices can be, for example, laptops 112, 113, and 114.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

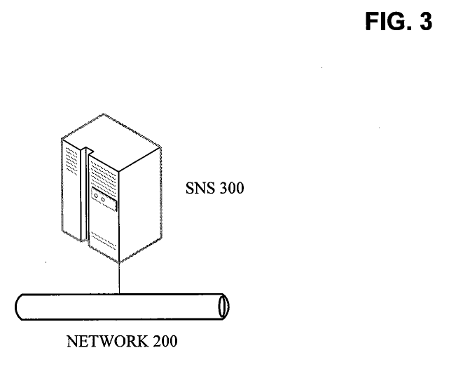

FIG. 3 illustrates an example Social Networking Server (SNS) 300 for managing a user's social networks. One embodiment of SNS 300 is described in more detail below in conjunction with FIG. 4. Briefly, however, SNS 300 may include any computing device capable of connecting to a network 200 to manage requests from client devices such as client devices, discussed above. Devices that may operate as SNS 300 include personal computers desktop computers, multiprocessor systems, microprocessor-based, mainframe, supercomputer or programmable consumer electronics, network PCs, servers, and the like.

SNS 300 may be configured to receive information associated with a user and to enable the user to customize a view based in part, on the received information. The received information may include, but is not limited to, profile information, category information, an activity, membership information associated with a category, and the like.

SNS 300 may also enable another social network user, such as a user of one of client devices, to view the customized view based on the received criteria. SNS 300 may employ a web service, email service, and the like, to make face management available to the other social network user, as appropriate.

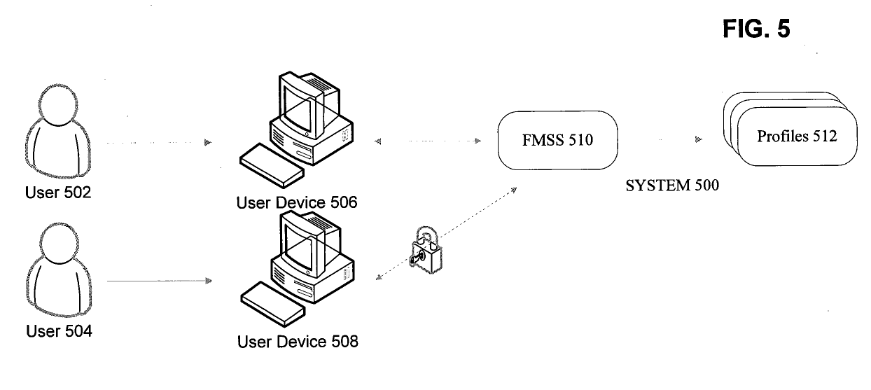

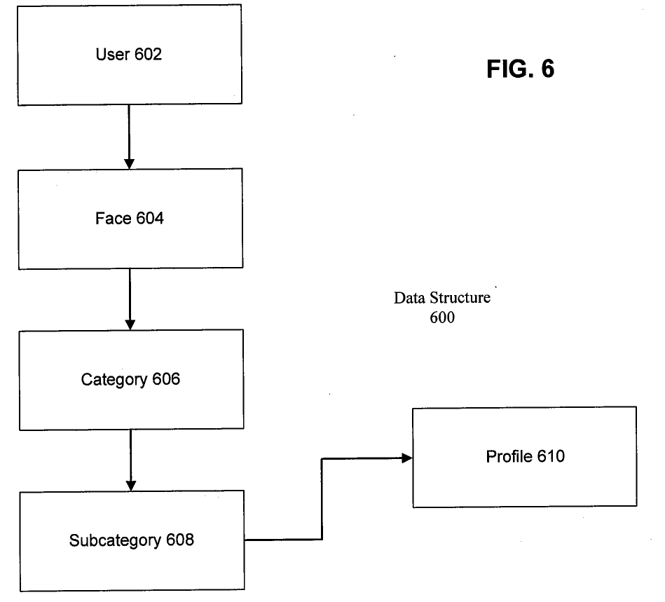

SNS 300 may employ processes such as described in more detail below in conjunction with FIGS. 5-6 to manage the customized views. Server 300 also includes input/output interface for communicating with external devices, such as a mouse, keyboard, scanner, or other input devices not shown in FIG. 3. Likewise, server 300 may further include additional mass storage facilities such as CD-ROM/DVD-ROM drive and hard disk drive.

FIG. 4 illustrates an example data storage system for managing a user's social networks. Server 400 includes processing unit 412, video display adapter 414, and a mass memory, all in communication with each other via bus 422. The mass memory generally includes RAM 416, ROM 432, and one or more permanent mass storage devices 428, such as hard disk drive, tape drive, optical drive, and/or floppy disk drive. The mass memory stores operating system 420 for controlling the operation of server 400. Any general-purpose operating system may be employed. Basic input/output system (“BIOS”) 418 is also provided for controlling the low-level operation of server 400. As illustrated in FIG. 3, server 400 also can communicate with the Internet, or some other communications network, such as a network illustrated in FIG. 1, via network interface unit 410, which is constructed for use with various communication protocols including the TCP/IP protocol. Network interface unit 410 is sometimes known as a transceiver, transceiving device, network interface card (NIC), and the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 454, 456, and 458 are loaded into mass memory and run on operating system 420. Examples of application programs include email programs, schedulers, calendars, web services, transcoders, database programs, word processing programs, spreadsheet programs, and so forth.

Server 400 is used to maintain a database, text, folder, file, and the like, that is configured to maintain and store information that identifies a registered user, their faces information and their associated profile information.

The server 400 may reside in the same physical computing device or separate device as a SNS, illustrated above. Alternatively, the server 400 can be a separated computing device to avoid single failure. Server 400 also includes input/output interface 424 for communicating with external devices, such as a mouse, keyboard, scanner, or other input devices not shown in FIG. 4. Likewise, server 400 may further include additional mass storage facilities such as CD-ROM/DVD-ROM drive and hard disk drive.

FIG. 5 illustrates an example Face Manager Software System (FMSS) for managing a user's social networks. Face Manager Software System (FMSS)—System 500 is a software system that is used by registered social networking users to manage their face information.

A face may represent a special mode of users within a user's social network, such as professional, academic, sports, family, entertainments, and the like. Typically, social network users establish their own faces and profile information based on they need. However, the invention is not so limited, and global default face may be established that provide profile information about a social network user to virtually any other social network user. Each face may include a set of user-definable social profile information. When the user-face is user-definable, the set of social network user information (profile information) may also be user-definable. Under each face, the user can include any activities, virtually any way, manner, and the like, in which a social network user may select to employ their social network connections. For example, activities may include, but are not limited to, dating, careers, military, alumni, help, advice, expertise, and the like.

Every new registered user will automatically triggered to create an entry in this system 500, and a default face will be created. The user can then create a hierarchy system as he/she desires, and manages whichever way that they want. The user can link with another registered user through one of his/her face. The invited registered user can accept or reject the invitation through one of his/her face, if the face is not specified; the default face will be utilized.

One or more users 502 and 504 can utilize user devices 506 and 508 to interact with an FMSS 510. Communications between the user devices 508 and the FMSS 510 can be encrypted or otherwise secured. The FMSS 510 can create and maintain profiles 512 responsive to user and other outside inputs.

FIG. 6 illustrates an example Profile Storage System (PSS) data structure for managing a user's social networks. The data structure 600 can be stored as a database, text, folder, file, and the like, and configured to maintain and store a profile associated with a social network user-face. A profile may include information associated with the social network user-face. For example, the profile may include, but is not limited to such information as the social network user's name, alias, nickname, age, email address, and the like. In one embodiment, a collection of such information may be arranged to provide a basic profile for the social network user. Additional information may also be included that includes category profile information, activity profile information, group profile information, relationship strength profile information, and the like. Such additional information may include, but is not limited, to a photograph, a hobby, a job history, a school history, career information, dating information, military information, sports information, religious information, sexual orientation, politics, interests, favorite sites, self-description, and the like. The additional information may further include such online status, including, but not limited to a current audio file being played, such as a current song, or the like, a favorite picture, a favorite group, blog, journal entry, file, update on a friend, and the like. In one embodiment, at least some information includes a Universal Resource Locator (URL). Virtually any information associated with the social network user-face may be included within system 600.

Moreover, the data structure 600 may store and maintain criteria associated with how profile information may be viewed by another social network user-face. For example, profile system 600 may include criteria indicating that only a member of a particular category may view a particular photograph, a subset of profile information, and the like. While information may be selected at a field by field level of granularity, the present invention however, is not so limited. For example, the present invention enables the social network user to establish criteria that is based on a relationship between the prospective viewer and the user. The relationship criteria may then be employed to map various collections, groupings, sets, and the like, of profile information, rather than merely toggling on/off individual viewers for all the profile information or individual profile fields. As such, the social network user, for example, may establish criteria such that any other social network user that is within some predetermined degrees of separation may view a predetermined set of profile information. Moreover, an entry in data structure 600 can be used by one social network user-face, or can be shared by multiple faces under the same users.

A user 602 can be associated with one or more faces 604, category 606, subcategory 608, and profiles 610. In an example embodiment, the data structure is stored in a relational database indexed for fast search and retrieval.

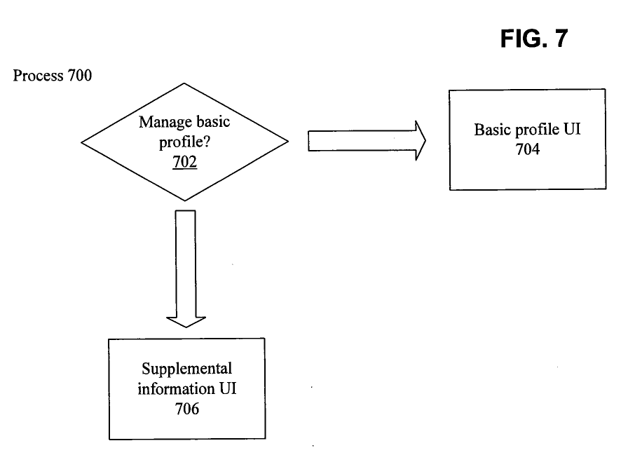

FIG. 7 illustrates an example procedure for receiving user profile information. The operation of certain aspects of the present invention will now be described with respect to FIG. 7. Briefly, FIG. 7 illustrate a logical flow diagram generally showing one embodiment of a process for enabling social network users to customize a view of their profile information. Process 700 may be implemented, for example, within SNS 300 of FIG. 3, and accessed employing a client device, such as client devices 100 of FIG. 1.

Process 700 is typically entered when a social network user that is registered to employ the customization process indicates intent to manage a view of their profile. Thus, process 700 begins at decision block 702, where a determination is made whether the social network user wishes to manage their basic profile. Typically, if the social network user has not provided basic user profile information, such as when the user has just registered, or the like, then the answer to decision block 702 may be yes. In any event, if it is determined that the social network user is to manage their basic profile, processing branches to block 704, where a user interface is provided for the user to manage the basic profile; otherwise, processing continues to 706, where a user interface is provided for the user to manage supplemental information.

In one embodiment, the user profile may be created quickly by automatically importing predetermined user data from a variety of sources, including, but not limited, to the user's email address book, group associations, and the like. In an example embodiment, the data structure is stored in a relational database utilizing partition, index and hints for fast search and retrieval.

The following is mathematical explanation: there exist at least three categories of value (user utility) that networks can provide: the linear value (N, where N=number of users), those are primary services that are aimed at individual users. The “square” value (N̂2, where N=number of users), those are derived from facilitating transactions. And exponential value (2̂N, where N=number of users), those are generated from facilitating group affiliations.

The dominant value in a typical network tends to shift from one category to another as the scale of the network increases. In a network dominated by linear connectivity value growth, “content is king.” That is, in such networks, there are a small number of sources (publishers or makers) of content that every user selects from. The sources compete for users based on the value of their content (published stories, published images, standardized consumer goods).

Where Metcalfe's Law (N̂2) dominates, transactions become central. The stuff that is traded in transactions (be it email or voice mail, money, securities, contracted services, or whatnot) are king. And where the Reed's law dominates, the central role is filled by jointly constructed value (such as specialized newsgroups, communities, joint responses to RFPs, etc.).

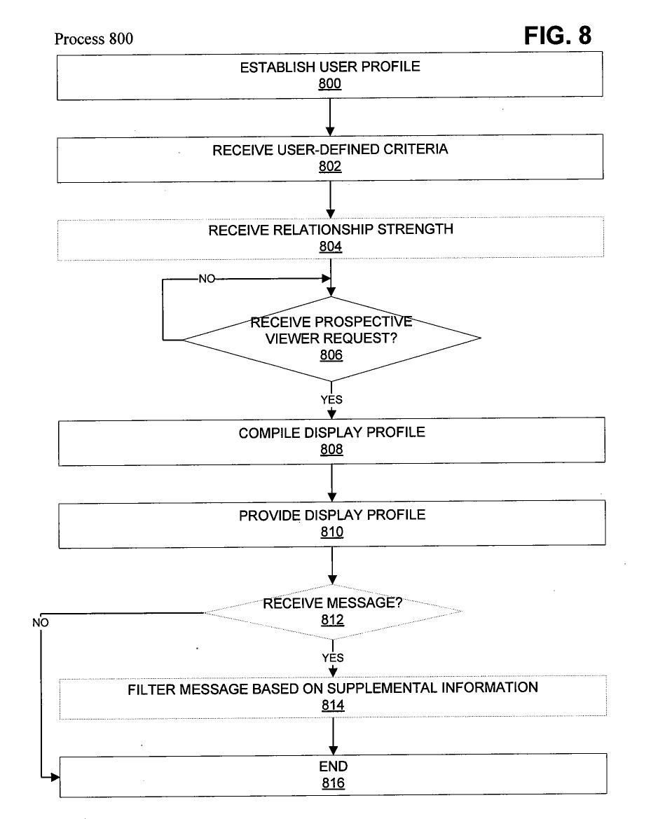

FIG. 8 illustrates an example procedure for providing a customized view of social network user information. Process 800 of FIG. 8 may be implemented, for example, on a SNS of FIG. 3. Process 800 can be executed when a social network user provides a request to view another social network user's profile.

In 800, the SNS can establish a user profile. In one example, the user profile can be retrieved or modified from a previously created user profile. In another example, the user profile can be created on request. The user profile can include both basic and supplemental information.

In 802, the SNS receives a user-defined criteria. For example, the user-defined criteria can define a filter as a relationship with a prospective viewer, as discussed above. Alternative user-defined criteria can also be used.

In 804, the SNS can optionally receive a relationship strength and a relationship with another user on a social network site. For example, this will allow the user to define not only relationships with other users, but also the strength of each of the relationships. This information is useful for filtering and compiling a display profile, discussed below.

In 806, the SNS can test whether a request to view a user profile has been received from a prospective viewer. For example, the request can be received at a computing device, discussed above. If the request has been received, the SNS proceeds to 808. If no request has been received, the SNS remains in 806.

In 808, the SNS can compile the display profile from available user information, including basic information and supplemental information. As discussed above, whether a piece of information is compiled into the display profile can depend on the user-defined criteria, a relationship between the user and the prospective viewer, or other conditions.

In 810, the SNS can provide the display profile to the prospective viewer. For example, the display profile can be complied and transmitted from a user's mobile device. Alternatively, the user's mobile device can receive an identifier transmitted by the prospective viewer and upload the identifier to a server. The server then compiles the display profile, as discussed above, for transmission to the prospective viewer.

In 812, the SNS optionally tests whether a message was received. For example, the user can receive incoming messages from other users on one or more social networking sites. If a message is received, the SNS proceeds to 814. If no message is received, the SNS exits the procedure at 816.

In 814, the SNS optionally filters the received message based on supplemental information. In one example, the message is filtered out and not displayed if it is not sent as part of a user-specified category. In another example, the message is filtered out if it is not sent from a user with a minimum threshold level of relationship strength.

In 816, the SNS exits the procedure.

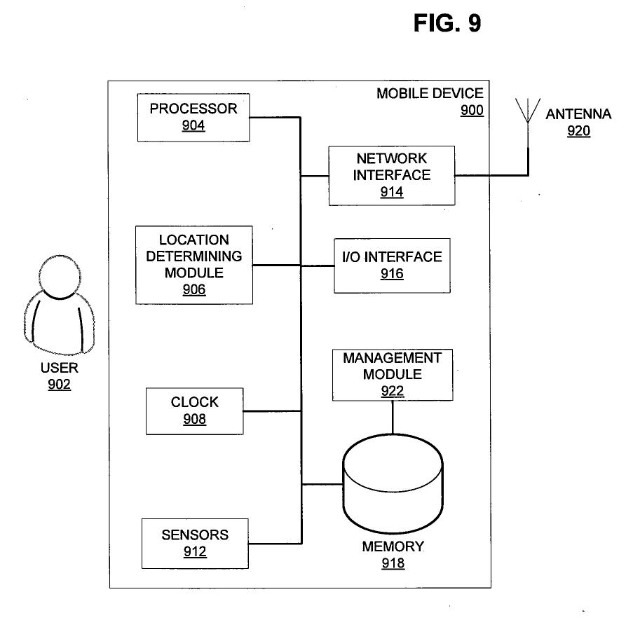

FIG. 9 illustrates an example mobile device for managing a user's social networks. The mobile device 900 can be a cellular phone, a PDA, or a similar portable device used by a user 902. The mobile device 900 is configured to allow a user to interact with a social network profile by executing a management application 922.

The mobile device 900 can include a processor 904. The processor 904 can be a general purpose processor configured to execute computer-readable instructions operating the mobile device 900 and associated peripherals. It will be appreciated that any number of processors can be included in the mobile device 900, including specialized processors. The processor 904 can also be configured to execute the management module 922, as discussed below.

The mobile device 900 can include a location determining module 906. The module 906 can be a GPS receiver module configured to receive GPS signals and calculate a physical location of the mobile device 900 based on the received GPS signals and an internal clock time. The physical location calculation can be optimized by, for example, averaging the GPS signals over time or incorporating a signal from a known nearby location. Alternatively, the module 906 can calculate a physical location by cellular signal triangulation or via short-range wireless network detection.

The mobile device 900 can include a clock 908. The clock 908 can provide a local time. The clock 908 can also provide an internal time for use with the GPS module. The clock 908 can be periodically updated from a server in communications with the mobile device 900.

The mobile device 900 includes additional sensors 912. Additional sensors can include audio input devices or optical input devices. Audio input devices can include microphones. Optical input devices can include cameras or light sensors. The sensors 912 can be configured to detect appropriate input and convert the input into input signals transmitted to the processor 902.

The mobile device 900 can include a network interface 914. For example, the network interface 914 can communicate with a cellular wireless network, a wired network such as Ethernet, or a short range wireless network such as Bluetooth or Wi-Fi. The mobile device 900 can include multiple network interfaces or a network interface configured to interface with multiple networks. Wireless network interfaces can communicate via an antenna 990.

An Ethernet network allows the mobile device 900 to communicate when plugged in. The mobile device 900 can be assigned an IP address on the wired network. A short-range wireless network can be a Wi-Fi, Wi-Bree or Bluetooth network.

The mobile device 900 can include an input/output interface 916. The interface 916 can receive user inputs from an input device and convert the user inputs into user commands. For example, input devices can include a touch screen display, a keypad, a microphone, an optical device, a pointer device, a scroll wheel, or other input devices.

The interface 916 can also transmit output to an output device in a form accessible to the user 902. For example, output devices can include a touch screen, a display screen, a speaker, an audio-out jack, an electro-mechanical motor for providing tactile output, or other output devices.

The mobile device 900 can include a memory 918. The memory 918 can be read-only or read-write, persistent or volatile storage memory accessible to the processor 904. The memory 918 can store data required by the mobile device 900 for operation and applications for execution.

The mobile device 900 can include an antenna 920. The antenna 920 can be configured to transmit and receive wireless signals from a wireless network.

The mobile device 900 can store and execute a management application 922. The management module 922 can be computer-readable executable code configured to interface with a SNS and allow the user 902 to interact with profiles on a social networking system, as discussed above.

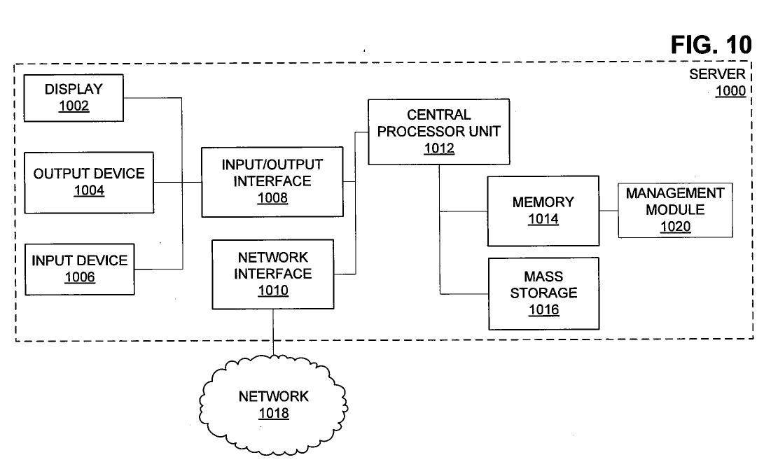

FIG. 10 illustrates an example server for managing a user's social networks. A server 1000 is configured to communicate with a mobile device, as illustrated in FIG. 9. The server 1000 can provide the functionality of an SNS as discussed above, or of any other computing device discussed above.

The server 1000 includes a display 1002. The display 1002 can be equipment that displays viewable images, graphics, and text generated by the server 1000 to a server administrator. For example, the display 1002 can be a cathode ray tube or a flat panel display such as a TFT LCD. The display 1002 includes a display surface, circuitry to generate a viewable picture from electronic signals sent by the server 1000, and an enclosure or case. The display 1002 can interface with an input/output interface 1008, which converts data from a central processor unit 1012 to a format compatible with the display 1002.

The server 1000 includes one or more output devices 1004. The output device 1004 can be any hardware used to communicate outputs to the administrator. For example, the output device 1004 can be audio speakers and printers or other devices for providing output.

The server 1000 includes one or more input devices 1006. The input device 1006 can be any hardware used to receive inputs from the administrator. The input device 1006 can include keyboards, mouse pointer devices, microphones, scanners, video and digital cameras, etc.

The server 1000 includes an input/output interface 1008. The input/output interface 1008 can include logic and physical ports used to connect and control peripheral devices, such as output devices 1004 and input devices 1006. For example, the input/output interface 1008 can allow input and output devices 1004 and 1006 to communicate with the server 1000.

The server 1000 includes a network interface 1010. The network interface 1010 includes logic and physical ports used to connect to one or more networks. For example, the network interface 1010 can accept a physical network connection and interface between the network and the workstation by translating communications between the two. Example networks can include Ethernet, the Internet, or other physical network infrastructure. Alternatively, the network interface 1010 can be configured to interface with a wireless network. Alternatively, the server 1000 can include multiple network interfaces for interfacing with multiple networks.

As illustrated, the network interface 1010 communicates over a network 1018. Alternatively, the network interface 1010 can communicate over a wired network. It will be appreciated that the server 1000 can communicate over any combination of wired, wireless, or other networks.

The server 1000 includes a central processing unit (CPU) 1012. The CPU 1012 can be an integrated circuit configured for mass-production and suited for a variety of computing applications. The CPU 1012 can sit on a motherboard within the server 1000 and control other workstation components. The CPU 1012 can communicate with the other workstation components via a bus, a physical interchange, or other communication channel.

The server 1000 includes memory 1014. The memory 1014 can include volatile and non-volatile storage memory accessible to the CPU 1012. The memory can be random access and provide fast access for graphics-related or other calculations. In an alternative embodiment, the CPU 1012 can include on-board cache memory for faster performance.

The server 1000 includes mass storage 1016. The mass storage 1016 can be volatile or non-volatile storage configured to store large amounts of data. The mass storage 1016 can be accessible to the CPU 1012 via a bus, a physical interchange, or other communication channel. For example, the mass storage 1016 can be a hard drive, a RAID array, flash memory, CD-ROMs, DVDs, HD-DVD or Blu-Ray mediums. In one embodiment, the mass memory device is a separate device functioning as a relational database system server. This enables distributed computing and avoids single failure.

The server 1000 communicates with a network 1018 via the network interface 1010. The network 1018 can be as discussed above in FIG. 2. The server 1000 can communicate with a mobile device over the network 1018.

The server 1000 can execute a management module 1020 stored in memory 1014. The management module 1020 can interface with a mobile device as illustrated in FIG. 9 and provide functionality discussed above in allowing a user to view and control a profile on a social networking site.

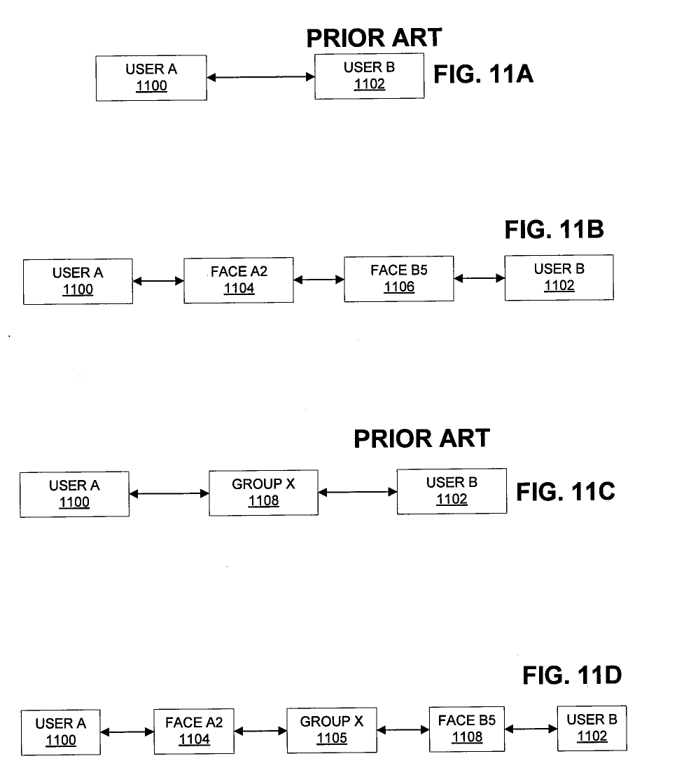

FIG. 11A illustrates a prior art relationship between users in a social networking environment. In the relationship, user A 1100 is connected to user B 1102. For example, each user can maintain a profile on an online social networking site.

FIG. 11B illustrates an example relationship between users in a face-oriented social networking environment. In the face-oriented social network environment, each user is associated with one or more faces. For example, user A 1100 is associated with face A2 1104. Similarly, user B 1102 is associated with face B5 1106. Users relate to each other through one or more of their faces.

In one example, users A 1100 and B 1102 are co-workers. Both users share an employer and each has a face associated with employer-related contacts. This allows each user to segregate employer-related relationships from other relationships, such as personal relationships.

It will be appreciated that each user can be associated with any number of faces, and users can be linked through multiple faces. For example, a first user can have both a professional and a personal relationship with a second user.

FIG. 11C illustrates a prior art relationship between users belonging to a group in a social networking environment. The relationship is based on both users A 1100 and B 1102 participating in group X 1108.

FIG. 11D illustrates an example relationship between users belonging to a group in a face-oriented social networking environment. The relationship between users A 1100 and B 1102 and group X 1105 further includes the face of each user. In this way, users can participate in different groups using different faces, thus segregating personal groups from professional groups.

In one embodiment, a user can create a user master profile and one or more user sub-profiles. Each sub-profile is associated with the master profile. The master profile is associated with a set of access rights, for example, a set of online accounts owned by the user. After logging into the user master profile, the user can access any of the associated online accounts.

In contrast, each sub-profile is associated with a subset of access rights. Each of the master profile and sub-profiles are associated with its own username and password pair. For example, a user can associated the master profile with account A at social networking site A, account B at social networking site B, and account C at social networking site C. A sub-profile is only associated with accounts A and B. Thus, when the user logs in with the sub-profile, only accounts A and B are accessible. In this example, the user can access the master profile from home, while accessing the sub-profile from work. Thus, account C is not visible when the user logs in with login information associated with the sub-profile.

It will be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

As discussed above, one embodiment of the present invention can be a method for managing a social network. The method includes establishing a user profile, wherein the user profile includes basic information fields and supplemental information fields. The method includes receiving a user-defined criteria defining how a display profile will be compiled based, in part, on a relationship to a prospective viewer. The method includes, responsive to a request from the prospective viewer, compiling fields from the basic information fields and the supplemental information fields into the display profile. The method includes providing the display profile to the prospective viewer. The user-defined criteria can include at least one of: a degree of separation within a social network, a pre-existing relationship to the prospective viewer, and an activity-based criterion. The method includes receiving a strength of a relationship with a user of the social network, wherein the display profile is compiled, in part, based on the strength of the relationship. The basic information fields can include user demographic information. The supplemental information fields can include at least one of: a category, an activity, an affiliation with an online social group, and an affiliation with an offline social group. The method includes receiving an incoming message from a user of the social network. The method includes filtering the incoming message based on the supplemental information fields. The request can be received at a mobile device. The display profile can be transmitted to the prospective viewer from a server.

Another embodiment of the present invention can be a server for managing a social network. The server includes a processor. The processor can be configured to establish a user profile, wherein the user profile includes basic information fields and supplemental information fields. The processor can be configured to receive a user-defined criteria defining how a display profile will be compiled based, in part, on a relationship to a prospective viewer. The processor can be configured to, responsive to a request from the prospective viewer, compile fields from the basic information fields and the supplemental information fields into the display profile. The processor can be configured to provide the display profile to the prospective viewer. The user-defined criteria can include at least one of: a degree of separation within a social network, a pre-existing relationship to the prospective viewer, and an activity-based criterion. The processor can be configured to receive a strength of a relationship with a user of the social network, wherein the display profile is compiled, in part, based on the strength of the relationship. The basic information fields can include user demographic information. The supplemental information fields can include at least one of: a category, an activity, an affiliation with an online social group, and an affiliation with an offline social group. The processor can be configured to receive an incoming message from a user of the social network. The processor can be configured to filter the incoming message based on the supplemental information fields. The request can be received at a mobile device. The display profile can be transmitted to the prospective viewer from a server.

Another embodiment of the present invention can be a computer-readable storage medium including instructions adapted to execute a method for managing a social network. The method includes establishing a user profile, wherein the user profile includes basic information fields and supplemental information fields. The method includes receiving a user-defined criteria defining how a display profile will be compiled based, in part, on a relationship to a prospective viewer. The method includes, responsive to a request from the prospective viewer, compiling fields from the basic information fields and the supplemental information fields into the display profile. The method includes providing the display profile to the prospective viewer. The user-defined criteria can include at least one of: a degree of separation within a social network, a pre-existing relationship to the prospective viewer, and an activity-based criterion. The method includes receiving a strength of a relationship with a user of the social network, wherein the display profile is compiled, in part, based on the strength of the relationship. The basic information fields can include user demographic information. The supplemental information fields can include at least one of: a category, an activity, an affiliation with an online social group, and an affiliation with an offline social group. The method includes receiving an incoming message from a user of the social network. The method includes filtering the incoming message based on the supplemental information fields. The request can be received at a mobile device. The display profile can be transmitted to the prospective viewer from a server.

Another embodiment of the present invention can be method for managing a user profile. The method includes, responsive to receiving a user-submitted authentication information, retrieving an associated user profile, wherein the user profile is at least one of: a user master profile associated with a set of access rights and a user sub-profile, wherein the user sub-profile is associated with the user master profile and a subset of access rights. The method includes providing access to the user based on the associated user profile and associated access rights. The authentication information can be a username and password pair.

The specific embodiments described in this document represent examples or embodiments of the present invention, and are illustrative in nature rather than restrictive. In the above description, for purposes of explanation, numerous specific details are set forth in order to provide a thorough understanding of the invention. It will be apparent, however, to one skilled in the art that the invention can be practiced without these specific details.

Reference in the specification to “one embodiment” or “an embodiment” or “some embodiments” means that a particular feature, structure, or characteristic described in connection with the embodiment is included in at least one embodiment of the present invention. Features and aspects of various embodiments may be integrated into other embodiments, and embodiments illustrated in this document may be implemented without all of the features or aspects illustrated or described. It will be appreciated to those skilled in the art that the preceding examples and embodiments are exemplary and not limiting.

While the system, apparatus and method have been described in terms of what are presently considered to be the most practical and effective embodiments, it is to be understood that the disclosure need not be limited to the disclosed embodiments. It is intended that all permutations, enhancements, equivalents, combinations, and improvements thereto that are apparent to those skilled in the art upon a reading of the specification and a study of the drawings are included within the true spirit and scope of the present invention. The scope of the disclosure should thus be accorded the broadest interpretation so as to encompass all such modifications and similar structures. It is therefore intended that the application includes all such modifications, permutations and equivalents that fall within the true spirit and scope of the present invention.

What is claimed is:

1. A method for managing a social network, comprising:
establishing a user profile, wherein the user profile includes basic information fields and supplemental information fields;
receiving a user-defined criteria defining how a display profile will be compiled based, in part, on a relationship to a prospective viewer;
responsive to a request from the prospective viewer, compiling fields from the basic information fields and the supplemental information fields into the display profile; and
providing the display profile to the prospective viewer.

2. The method of claim 1, wherein the user-defined criteria includes at least one of: a degree of separation within a social network, a pre-existing relationship to the prospective viewer, and an activity-based criterion.

3. The method of claim 1, further comprising:
receiving a strength of a relationship with a user of the social network, wherein the display profile is compiled, in part, based on the strength of the relationship.

4. The method of claim 1, wherein,
the basic information fields include user demographic information, and
the supplemental information fields include at least one of: a category, an activity, an affiliation with an online social group, and an affiliation with an offline social group.

5. The method of claim 4, further comprising:
receiving an incoming message from a user of the social network; and
filtering the incoming message based on the supplemental information fields.

6. The method of claim 1, wherein the request is received at a mobile device.

7. The method of claim 6, wherein the display profile is transmitted to the prospective viewer from a server.

8. A server for managing a social network, comprising:
a processor, the processor configured to
establish a user profile, wherein the user profile includes basic information fields and supplemental information fields,
receive a user-defined criteria defining how a display profile will be compiled based, in part, on a relationship to a prospective viewer,
responsive to a request from the prospective viewer, compile fields from the basic information fields and the supplemental information fields into the display profile, and
provide the display profile to the prospective viewer.

9. The server of claim 8, wherein the user-defined criteria includes at least one of: a degree of separation within a social network, a pre-existing relationship to the prospective viewer, and an activity-based criterion.

10. The server of claim 8, the processor further configured to,
receive a strength of a relationship with a user of the social network, wherein the display profile is compiled, in part, based on the strength of the relationship.

11. The server of claim 8, wherein,
the basic information fields include user demographic information, and
the supplemental information fields include at least one of: a category, an activity, an affiliation with an online social group, and an affiliation with an offline social group.

12. The server of claim 11, the processor further configured to,
receive an incoming message from a user of the social network, and
filter the incoming message based on the supplemental information fields.

13. The server of claim 8, wherein the request is received at a mobile device.

14. The server of claim 13, wherein the display profile is transmitted to the prospective viewer from a server.

15. A computer-readable storage medium including instructions adapted to execute a method for managing a social network, the method comprising:
establishing a user profile, wherein the user profile includes basic information fields and supplemental information fields;
receiving a user-defined criteria defining how a display profile will be compiled based, in part, on a relationship to a prospective viewer;
responsive to a request from the prospective viewer, compiling fields from the basic information fields and the supplemental information fields into the display profile; and
providing the display profile to the prospective viewer.

16. The medium of claim 15, wherein the user-defined criteria includes at least one of: a degree of separation within a social network, a pre-existing relationship to the prospective viewer, and an activity-based criterion.

17. The medium of claim 15, the method further comprising:
receiving a strength of a relationship with a user of the social network, wherein the display profile is compiled, in part, based on the strength of the relationship.

18. The medium of claim 15, wherein,
the basic information fields include user demographic information, and
the supplemental information fields include at least one of: a category, an activity, an affiliation with an online social group, and an affiliation with an offline social group.

19. The medium of claim 18, the method further comprising:
receiving an incoming message from a user of the social network; and
filtering the incoming message based on the supplemental information fields.

20. The medium of claim 15, wherein the request is received at a mobile device and the display profile is transmitted to the prospective viewer from a server.

21. A method for managing a user profile, comprising:
responsive to receiving a user-submitted authentication information, retrieving an associated user profile, wherein the user profile is at least one of: a user master profile associated with a set of access rights and a user sub-profile, wherein the user sub-profile is associated with the user master profile and a subset of access rights; and
providing access to the user based on the associated user profile and associated access rights.

22. The method of claim 21, wherein the authentication information is a username and password pair.
